(19) United States
(12) Patent Application Publication
(10) Pub. No.: US 2008/0056667 A1
(43) Pub. Date: Mar. 6, 2008

(54) Video recording and reproducing apparatus

(75) Inventors: Michihiro Fujiyama, Kyotanabe City (JP); Daisuke Nakajima, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Moriguchi City (JP)

(21) Appl. No.: 11/896,339

(22) Filed: Aug. 31, 2007

(30) Foreign Application Priority Data
Sep. 1, 2006 (JP) 2006-238065

(51) Int. Cl. H04N 5/91

(52) U.S. Cl. 386/65

(57) ABSTRACT

During recording, recorded images are grouped such that when a system time at the time of input of an image intended to be recorded this time is later than a recorded time of an image recorded last time, the image that is recorded this time is included in a current recorded image group, and when the system time at the time of input of the image intended to be recorded this time is earlier than the recorded time of the image recorded last time, a new recorded image group is formed from the image that is recorded this time. A group management information file is then created for each group.

### BACKGROUND OF THE INVENTION

1. Field of the Invention

The present invention relates to a video recording and reproducing apparatus.

2. Description of the Related Art

Among video recording and reproducing apparatuses, in an apparatus corresponding to the summer time, time return occurs when the time returns from the summer time to the standard time. Further, also in a typical video recording and reproducing apparatus, the time return may occur due to a change in time made by the user.

When the time return occurs, even images actually recorded at Apparently different time points may have almost and identical recorded time. In a case where a plurality of recorded images are present whose recorded times are almost identical due to the time return, when a time in the vicinity of the recorded times of those plurality of recorded images is designated by search by time designation, there has hitherto been a problem as described below.

As shown in FIG. 1, when only a recorded image A found first is displayed as a search result among a plurality of recorded images corresponding to a designated time (search time), another recorded image B recorded at the identical recorded time to the designated time is not found. It is to be noted that in FIG. 1, an oblique solid lines represent implementation of recording.

Moreover, as shown in FIG. 2, when only a recorded image B whose recorded time is completely identical to the designated time (search time) is searched, another recorded image A whose recorded time is close to the designated time is not searched.

### SUMMARY OF THE INVENTION

It is an object of the present invention to provide a video recording and reproducing apparatus capable of facilitating search of all recorded images in the vicinity of a designated time by search by time designation.

A first video recording and reproducing apparatus according to the present invention is an apparatus in which index information made up of a recorded time of an image and a storage address of the image is stored into a storage unit every time an image is recorded into the storage unit during recording, the apparatus comprising: a group management information file creating circuit which groups recorded images, during recording, such that when a system time at the time of input of an image intended to be recorded this time is later than a recorded time of an image recorded last time, the image that is recorded this time is included in a current recorded image group, and when the system time at the time of input of the image intended to be recorded this time is earlier than the recorded time of the image recorded last time, a new recorded image group is formed from the image that is recorded this time, and the group management information file creating circuit which creates, for each group, a group management information file which stores group management information including a start time as a recorded time of an image recorded first within the group, an end time as a recorded time of an image recorded last within the group, and an address at which index information of the image recorded first within the group is stored in the storage unit; a circuit which performs, during search by time designation, a primary search process to search one group management information file where a designated time is present between the start time and the end time; and a circuit which, when one group management information file is found where the designated time is present between the start time and the end time during the primary search process, performs a secondary search process to search a recorded image having a recorded time closest to the designated time based upon index information of the recorded images in the group corresponding to the group management information file.

A second video recording and reproducing apparatus according to the present invention is an apparatus in which index information made up of a recorded time of an image and a storage address of the image is stored into a storage unit every time an image is recorded into the storage unit during recording, the apparatus comprising: a group management information file creating circuit which groups recorded images, during recording, such that when a system time at the time of input of an image intended to be recorded this time is later than a recorded time of an image recorded last time, the image that is recorded this time is included in a current recorded image group, and when the system time at the time of input of the image intended to be recorded this time is earlier than the recorded time of the image recorded last time, a new recorded image group is formed from the image that is recorded this time, and the group management information file creating circuit which creates, for each group, a group management information file which stores group management information including a start time as a recorded time of an image recorded first within the group, an end time as a recorded time of an image recorded last within the group, and an address at which index information of the image recorded first within the group is stored in the storage unit; a circuit which performs, during search by time designation, a primary search process to search one group management information file where a designated time is present between the start time and the end time, sequentially from a group management information file stored during the last search as a subject file for start of next primary search; and a circuit which, when one group management information file is found where the designated time is present between the start time and the end time during the primary search process, performs a secondary search process to search a recorded image having a recorded time closest to the designated time based upon index information of the recorded images in the group corresponding to the group management information file, and stores a group management information file that was intended to be subjected to the primary search process subsequent to the found group management information file, as a subject file for start of the next primary search.

In the first video recording and reproducing apparatus or the second video recording and reproducing apparatus, the group management information file creating circuit may include, for example, a circuit which determines whether or not a return time as a difference between the recorded time of the image recorded last time and the system time at the time of input of the image intended to be recorded this time is not larger than a prescribed value when the system time is earlier than the recorded time of the image recorded last time; and a circuit which makes a new recorded image group formed from the image that is recorded this time when the return time is larger than the prescribe value, and makes the recorded time of the image that is intended to be recorded this time changed to a time later than the recorded time of the image recorded last time, while making the image that is recorded this time included in the current recorded image group, when the return time is not larger than the prescribed value.

A third video recording and reproducing apparatus according to the present invention is an apparatus in which index information made up of a recorded time of an image and a storage address of the image is stored into a storage unit every time an image is recorded into the storage unit during recording, the apparatus comprising: a group management information file creating means which groups recorded images, during recording, such that when a system time at the time of input of an image intended to be recorded this time is later than a recorded time of an image recorded last time, the image that is recorded this time is included in a current recorded image group, and when the system time at the time of input of the image intended to be recorded this time is earlier than the recorded time of the image recorded last time, a new recorded image group is formed from the image that is recorded this time, and the group management information file creating means which creates, for each group, a group management information file which stores group management information including a start time as a recorded time of an image recorded first within the group, an end time as a recorded time of an image recorded last within the group, and an address at which index information of the image recorded first within the group is stored in the storage unit; a means which performs, during search by time designation, a primary search process to search one group management information file where a designated time is present between the start time and the end time; and a means which, when one group management information file is found where the designated time is present between the start time and the end time during the primary search process, performs a secondary search process to search a recorded image having a recorded time closest to the designated time based upon index information of the recorded images in the group corresponding to the group management information file.

In the third video recording and reproducing apparatus, the group management information file creating means may include, for example, a means which determines whether or not a return time as a difference between the recorded time of the image recorded last time and the system time at the time of input of the image intended to be recorded this time is not larger than a prescribed value when the system time is earlier than the recorded time of the image recorded last time; and a means which makes a new recorded image group formed from the image that is recorded this time when the return time is larger than the prescribe value, and makes the recorded time of the image that is intended to be recorded this time changed to a time later than the recorded time of the image recorded last time, while making the image that is recorded this time included in the current recorded image group, when the return time is not larger than the prescribed value.

### BRIEF DESCRIPTION OF THE DRAWINGS

FIG. 1 is a graph showing the case of displaying as a search result only a recorded image A found first among a plurality of recorded images corresponding to a designated time (search time);

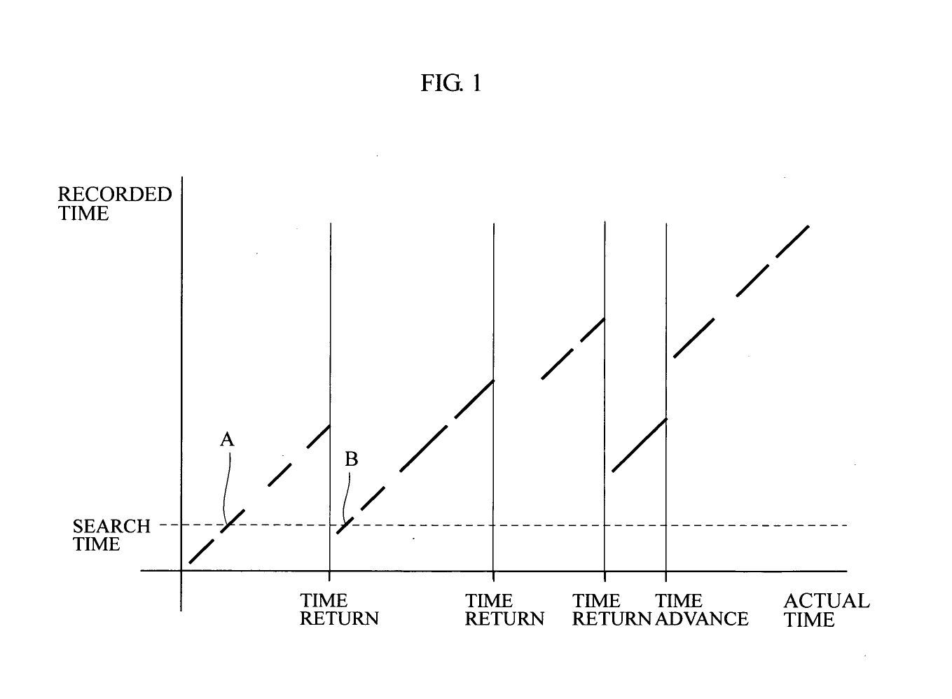

FIG. 2 is a graph showing the case of searching only a recorded image B searched at a completely identical recorded time to the designated time (search time);

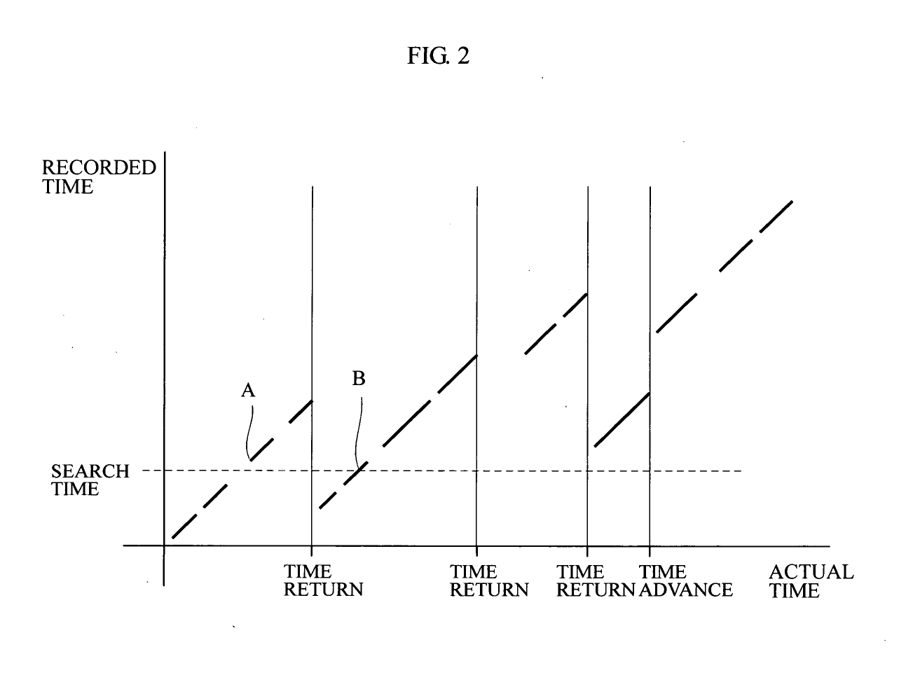

FIG. 3 is a block diagram showing an electric configuration of a monitoring system;

FIG. 4 is a graph for explaining a concept of an embodiment of the present invention;

FIG. 5 is a pattern view showing an example of contents of a big basis file;

FIG. 6 is a flowchart showing a proceeding of a big basis file creation process;

FIG. 7 is a flowchart showing a procedure for a recorded time changing process which is performed in Step S5 of FIG. 6;

FIG. 8 is a pattern view for explaining the process (recorded time changing process) of FIG. 7;

FIG. 9 is a flowchart showing a procedure for a search process which is performed during search; and

FIG. 10 is a flowchart showing a procedure for a primary search process based upon a big basis b which is performed in Step S28 of FIG. 9.

### DETAILED DESCRIPTION OF THE PREFERRED EMBODIMENTS

In the following, an example of the case of applying the present invention to a monitor system is described.

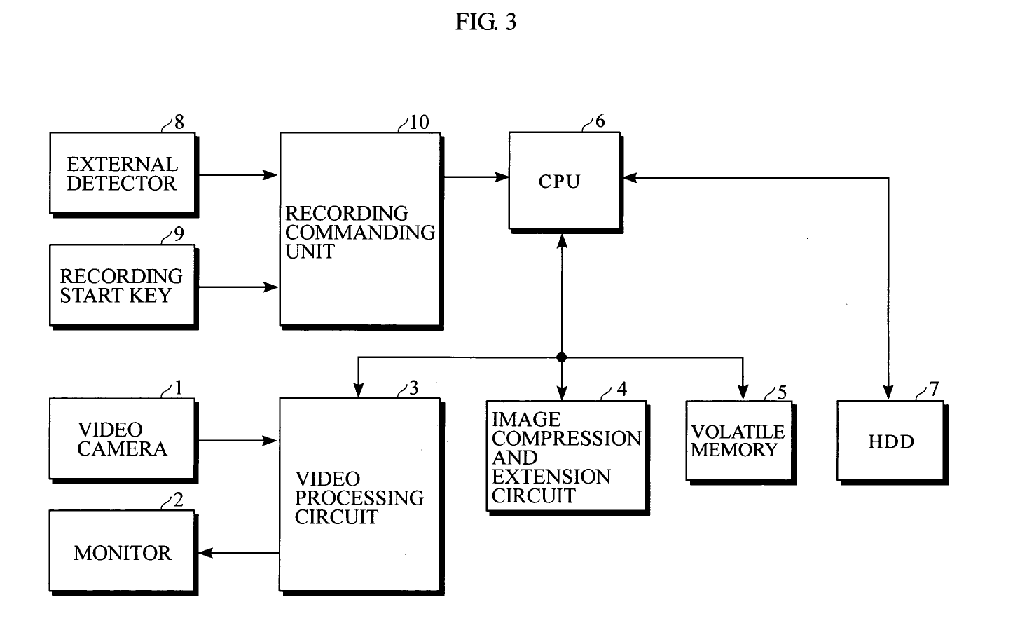

FIG. 3 shows an electric configuration of a monitor system.

This monitor system has a function to record an image inputted from a monitor camera, a sound inputted from a microphone, and other associated information, into a recording medium (in the present example, description will be made using a hard disc (HDD)), a function to reproduce an image and a sound recorded in the hard disc, and a function to search an image and a sound recorded in the hard disc. Here, recording, reproduction and search of an image alone is described for convenience of description.

In FIG. 3, numeral 1 denotes a video camera, numeral 2 denotes a monitor, numeral 3 denotes a video processing circuit, numeral 4 denotes an image compression and extension circuit, numeral 5 denotes a volatile memory, numeral 6 denotes a CPU, numeral 7 denotes a hard disc (HDD), numeral 8 denotes an external detector, numeral 9 denotes a recording start key, and numeral 10 denotes a recording commanding unit. The external detector 8 is, for example, a detector for detecting that a person or the like has entered a monitoring region.

A recording mode includes a normal recording mode and an alarm recording mode. The normal recording mode is a mode in which recording is started from a time point when a recording start key is pressed or from a recording start time set by a timer. The alarm recording mode is a mode in which recording is performed when an alarm signal has been outputted from the external detector 8. It is to be noted that a mode in which a change in image of inputted video picture is constantly monitored and recording is performed when the change in image is detected may be set as the alarm recording mode.

Only one of either the normal recording mode or the alarm recording mode may be set effective, or in a case where recording by the normal recording mode is being performed, when an alarm signal is outputted from the external detector 8 or a change in image is detected, recording by the alarm recording mode may be performed. It is to be noted that in general, a recording rate in the alarm recording mode is set higher than a recording rate in the normal recording mode.

An operation during recording is described. A video signal inputted from the video camera 1 is converted into a digital video signal by the video processing circuit 3, and then stored in the volatile memory 5. When the video signal stored into the volatile memory 5 is a video signal to be recorded, a video signal stored in the volatile memory 5 is compressed by the image compression and extension circuit 4, and then recorded in the HDD 7 via the CPU 6.

An operation during reproduction is described. When a reproduction command is inputted by an operational section, not shown, to the CPU 6, compressed video data is read from the HDD 7 and stored into the volatile memory 5 via the CPU 6. The compressed video data stored in the volatile memory 5 is extended by the image compression and extension circuit 4, and then converted into an analog video signal by the video processing circuit 3. The video signal obtained by the video processing circuit 3 is transmitted to the monitor 2 and displayed thereon.

During search, time (year, month, day and time) to be searched is designated by the operator, and a video picture corresponding to the designated time is read from the HDD 7. The same process as the process during reproduction is performed on the read video picture, thereby displaying the read video picture on the monitor 2.

A characteristic of this monitor system (characteristic of one embodiment of the present invention) is that, in a case where a plurality of recorded images are present whose recorded times are almost identical due to time return or the like, when a time in the vicinity of the recorded times of those plurality of recorded images is designated by search by time designation, all of the recorded images whose recorded times are in the vicinity of the designated time are made easy to search.

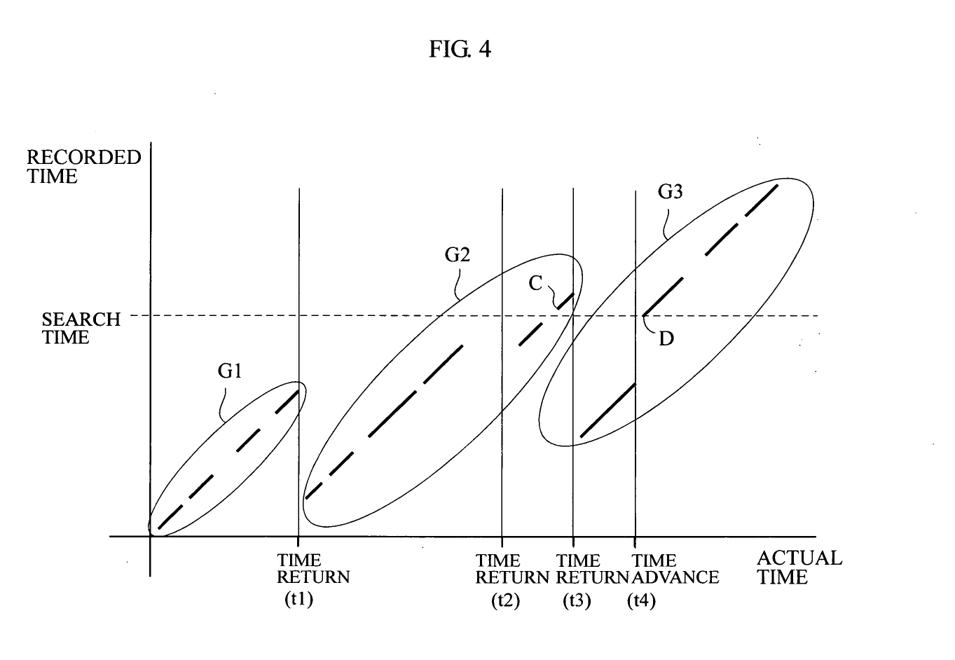

With reference to FIG. 4, a concept of one embodiment of the present invention is described.

In principle, recorded images which are recorded in a period from a time point at which the time return occurs to a time point at which next time return occurs are taken as one group. However, even in the case of occurrence of the time return, if a recorded time of an image recorded first after occurrence of the time return is advanced from a recorded time of an image recorded last before occurrence of the time return, recorded images are not grouped by the time return.

FIG. 4 shows an example where three times of time return (time points t1, t2, t3) and one time of time advance (time point t4) are present. Recorded images recorded until the first time return (t1) are taken as a group 1 (G1). Recorded images recorded in a period from the first time return (t1) to the third time return (t3) are taken as a group 2 (G2) since a recorded time of an image B recorded first after occurrence of the second time return (t2) is advanced from a recorded time of an image A recorded last before occurrence of the second time return (t2). Further, recorded images which are recorded after the third time return (t3) are taken as a group 3 (G3).

During recording, a file called a big basis file (group management information file) is created for each of the groups G1, G2 and G3. In the big basis file corresponding to each of the groups G1, G2 and G3, group management information such as a recorded time of an image recorded first within the group (“start time”) and a recorded time of an image recorded last within the group (“end time”) are recorded.

During search by time designation, first, one group where a designated time is present within the range from the start time to the end time is searched (primary search). This primary search is performed by determining whether or not the designated time is present within the range from the start time to the end time in the group, sequentially from a group corresponding to a big basis file stored during the last search as a subject file for start of next primary search. When one group where the designated time is present within the range from the start time to the end time is found, a recorded image, the recorded time of which is closest to the designated time, is searched (secondary search) from recorded images within the group. Further, a big basis file corresponding to a group subsequent to the group found by the primary search is stored as a subject file for start of the next primary search.

For example, in FIG. 4, when a search start subject group is the group 1 (G1) and a designated time is a search time shown in FIG. 4, the group 2 (G2) is found as a group where the designated time is present within the range from the start time to the end time in the primary search. Therefore, in the secondary search, a recorded image C having the recorded time closest to the designated time is searched from within the group 2 (G2). Further, a big basis file corresponding to the group 3 (G3) subsequent to the group 2 (G2) found by the primary search is stored as a subject file for start of the next primary search.

When the user restarts search by the same designated time in a case where the user looks at a searched image to find the image different from a desired one or some other cases, the primary search is started from the group 3 (G3). In the primary search, the group 3 (G3) is found as a group where the designated time is present within the range from the start time to the end time. In the secondary search, a recorded image D having the recorded time closest to the designated time is searched from within the group 3 (G3).

Therefore, in a case where a plurality of recorded images are present whose recorded times are almost identical due to time return, when a time in the vicinity of the recorded times of those plurality of recorded images is designated by search by time designation, all of the recorded images whose recorded times are in the vicinity of the designated time are made easy to search.

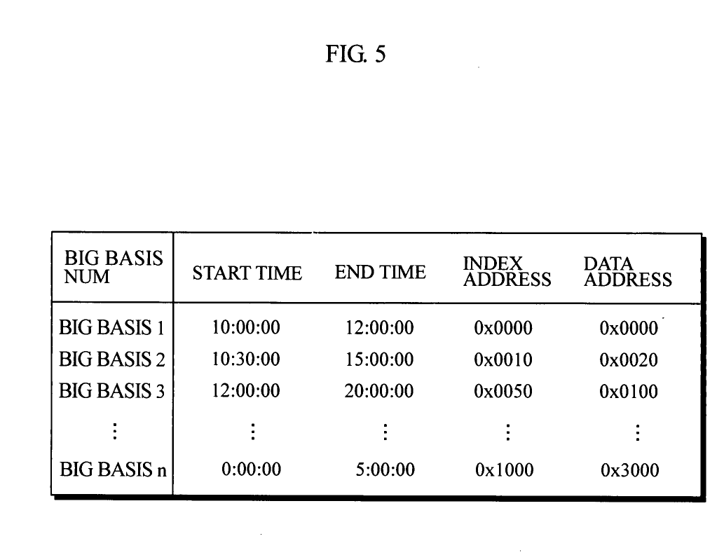

FIG. 5 shows contents of the big basis file.

As described above, the big basis file is created for each group of recorded images. Each big basis file is provided with a serial number (big basis number (num)). Into each big basis file a recorded time of an image recorded first within the group (“start time”), a recorded time of an image recorded last within the group (“end time”), an index address and a data address are written. Although information of the start time and the end time is in practice made up of information of a year/month/date and time, the information of a year/month/date is omitted in FIG. 5.

The index address shows a first address into which index information of each recorded image within the group is written among an index information storage area within the HDD. The data address shows a first address into which each recorded image data within the group is written among image data storage area within the HDD. It is to be noted that the index information of each recorded image is made up of information showing a recorded time of the recorded image and a storage address of the recorded image data.

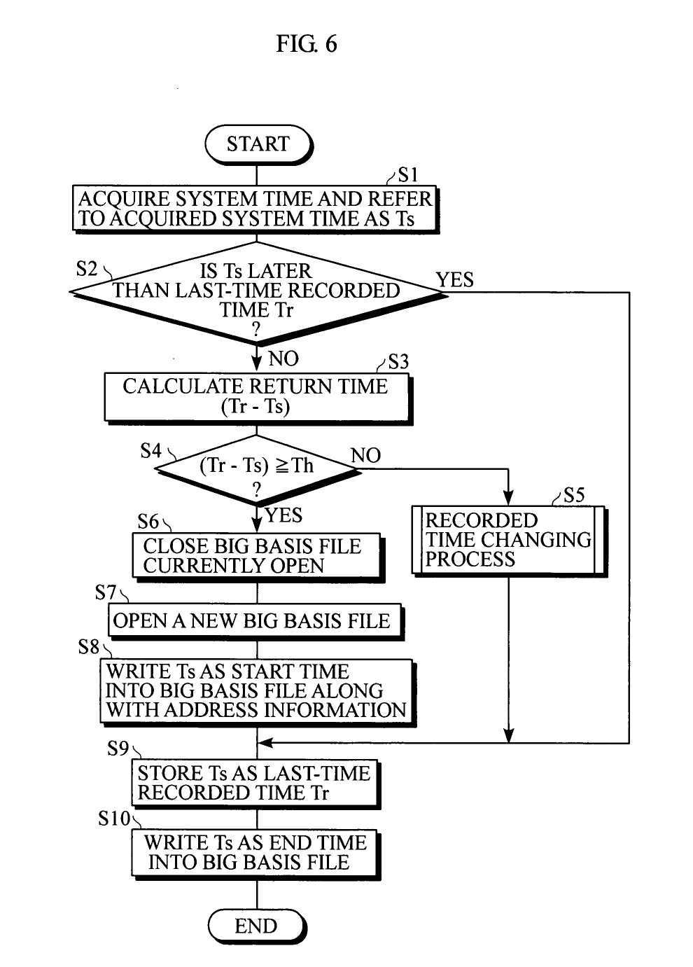

FIG. 6 shows a procedure for a big basis file creation process which is performed during recording.

The big basis file creation process is executed every time an image to be recorded is inputted. It is to be noted that, although index information is written into an index information storage area within the HDD every time one image is recorded, this process is omitted in the figure.

In addition, here, information showing a system time and a recorded time of an image is constituted of a year/month/date, an hour/minute/second, and digits smaller than the second. Further, the digits smaller than the second take values from “000” to “150”.

First, a system time is acquired, and the acquired system time is referred to as Ts (Step S1). It is determined whether or not Ts is later than a last-time recorded time Tr (Step S2). When Ts is later than the last-time recorded time, it is determined that time return has not occurred, and the process is shifted to Step S9.

When Ts is earlier than the last-time recorded time Tr, it is determined that the time return has occurred, and a returned time (Tr−Ts) is calculated (Step S3). It is then determined whether or not the returned time (Tr−Ts) is not smaller than a prescribed value Th (Step S4).

When the returned time (Tr−Ts) is smaller than the prescribed value Th, a recorded time changing process is performed (Step S5), and the process is then shifted to Step S9. Typically, the system time acquired in Step S1 is recorded as a recorded time corresponding to an image data to be recorded this time. However, in the recorded time changing process, as the recorded time corresponding to the image data, a time later than the last-time recorded time, i.e. a time later than the system time acquired in Step S1, is written. Subsequently, Ts is changed to the same date as the recorded time after the change. Details of the recorded time changing process is described later.

In Step S4, when it is determined that the returned time (Tr−Ts) is not smaller than the prescribed value Th, the big basis file currently open is closed (Step S6), and a new big basis file is opened (Step S7). Into the newly opened big basis file, the system time Ts acquired in Step S1 is written as the start time, and simultaneously, address information (index address and date address) is written (Step S8). The process is then shifted to Step S9.

In Step S9, Ts is stored as the last-time recorded time Tr. Thereafter, Ts is written as the end time into the big basis file currently open. It is to be noted that, when the end time has already been written into the big basis file currently open, the end time is updated to Ts.

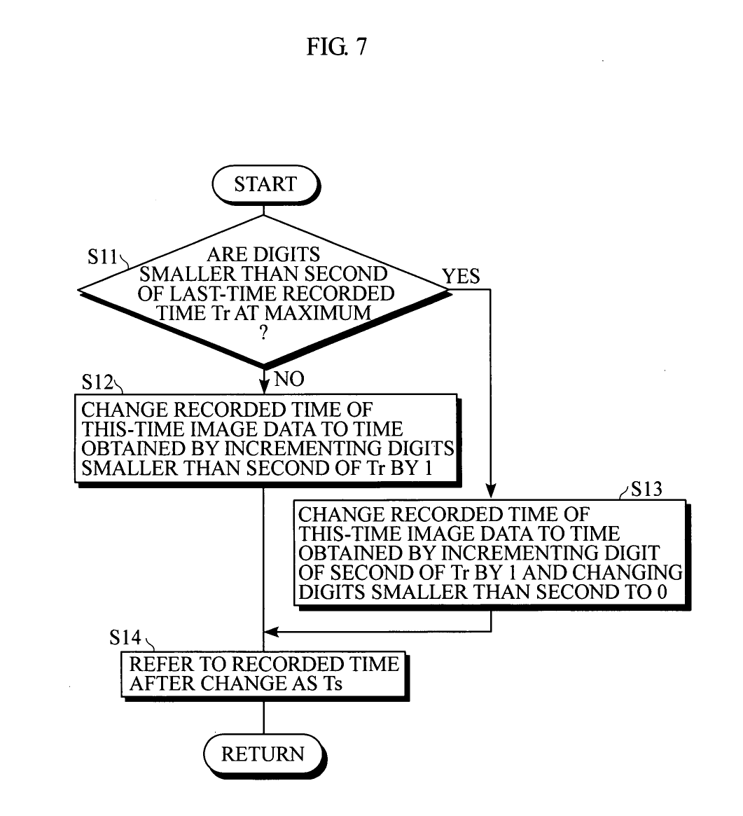

FIG. 7 shows a procedure for the recorded time changing process which is performed in Step S5 of FIG. 6.

In the recorded time changing process, it is determined whether or not the digits smaller than the second of the last-time recorded time Tr are at the maximum (150 in this example) (Step S11). When the digits smaller than the second of the last-time recorded time Tr are not at the maximum, the recorded time of this-time image data is changed to a time incremented from the digits smaller than the second of the last-time recorded time Tr by one (Step S12). The recorded time of this-time image data after the change is referred to as Ts (Step S14). The process is then shifted to Step S9.

In Step S11 above, when the digits smaller than the second of the last-time recorded time Tr are at the maximum, the recorded time of this-time image data is changed to a time obtained by incrementing the digit of the second of the last-time recorded time Tr by one and changing the digits smaller than the second to zero (Step S13). The recorded time of this-time image data after the change is referred to as Ts (Step S14). The process is then shifted to Step S9.

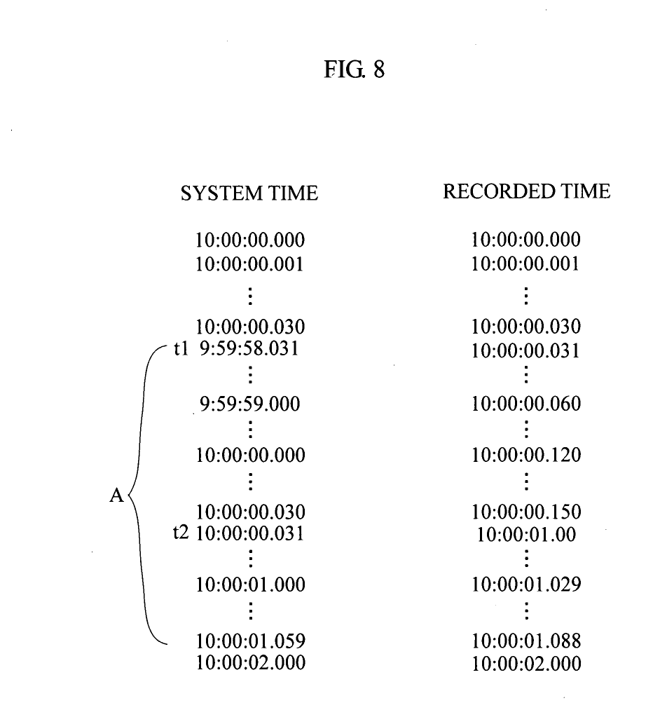

With reference to FIG. 8, the process (recorded time changing process) of FIG. 7 is described.

In FIG. 8, a system time is the system time acquired in Step S1 of FIG. 6. Here, a year/month/date is omitted, and an hour/minute/second and digits smaller than the second are shown. A recorded time is the recorded time of this-time image data. Here, a year/month/date is omitted, and an hour/minute/second and digits smaller than the second are shown.

A range indicated by A in FIG. 8 is the range where time return has occurred and the returned time (Tr−Ts) is smaller than the prescribed value Th.

At the time point t1, the system time Ts (9:59:58.031) is earlier than the last-time recorded time Tr (10:00:00.030). Further, the returned time (Tr−Ts) is smaller than the prescribed value Th.

In this case, since the digits smaller than the second of the last-time recorded time Tr (10:00:00.030) are not at the maximum, the recorded time of this-time image data is a time (10:00:10.31) obtained by incrementing the digits smaller than the second of the last-time recorded time Tr by one.

At the time point t2, since the digits smaller than the second of the last-time recorded time Tr (10:00:00.150) are at the maximum, the recorded time of this-time image data is a time (10:00:01.000) obtained by incrementing the digit of the second of the last-time recorded time Tr by one and changing the digits smaller than the second to zero.

As thus described, even if time return actually occurs, when the return time (Tr−Ts) is small, the recorded time is changed so as to prevent occurrence of the time return in terms of recorded times. Such a change is made so as to save the trouble of creating a new big basis file every time the return time (Tr−Ts) is small.

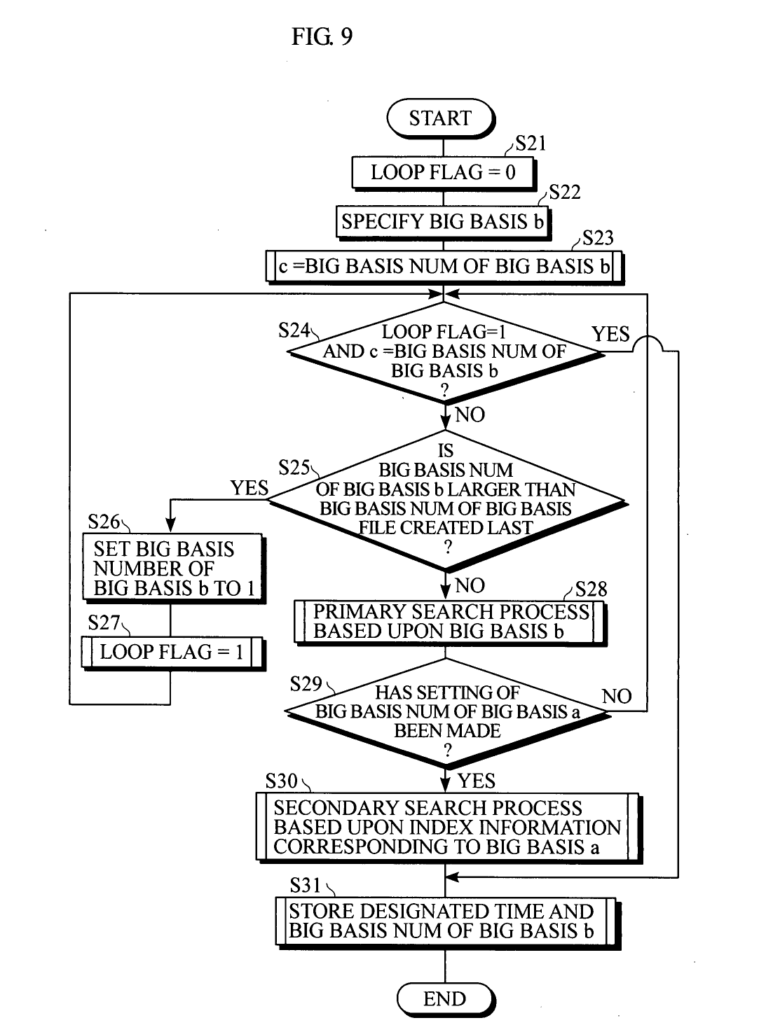

FIG. 9 shows a procedure for a search process which is performed during search.

In the following description, a big basis b represents a big basis file to be subjected to the primary search, and a big basis a is a big basis file searched by the primary search process.

A recorded time (designated time: year/month/date and hour/minute second) wished to be searched is inputted as the search start time. It is to be noted that a big basis number (big basis num) of a big basis file, from which the primary search is performed in the search process this time, has been stored as a big basis number (big basis num) of the big basis b during search process last time. However, one is set as the big basis number (big basis num) of the big basis b at power-on.

In the search process, first, a loop flag is reset (loop flag=0) (Step S21). The big basis b is specified based upon the big basis number of the big basis b (Step S22). Further, the big basis number (big basis num) of the big basis b is set as a variable number c (Step S23). It is then determined whether or not search end conditions that the loop flag=1 and the big basis number of the big basis b is equivalent to the variable number c are satisfied (Step S24).

When the above search end conditions are not satisfied, it is determined whether or not the big basis number of the big basis b is larger than the big basis number of the big basis file created last among big basis files already created (Step S25).

When it is determined that the big basis number of the big basis b is not larger than the big basis number of the big basis file created last, the process is advanced to Step S28.

In Step S25 above, when it is determined that the big basis number of the big basis b is larger than the big basis number of the big basis file created last, the big basis number of the big basis b is set to one (Step S26) and simultaneously, a loop flag is set (loop flag=1) (Step S27). Thereafter, the process is returned to Step S24.

In Step S28, the primary search process is performed based upon the big basis b. In the primary search process based upon the big basis b, it is determined whether or not a designated time is present between a start time and an end time of the big basis b, and when the designated time is present between the start time and the end time, the big basis number of the big basis b is set as the big basis number of the big basis a, and the big basis number of the big basis b is then incremented by one, to update the big basis number of the big basis b. When the designated time is not present between the start time and the end time, the big basis number of the big basis b is incremented by one, to update the big basis number of the big basis b. Details of the primary search process based upon the big basis b are described later.

When the primary search process based upon the big basis b is performed, it is determined whether or not the big basis number of the big basis a has been set by the primary search process (Step S29). When the big basis number of the big basis a is not set (No in Step S29), the process is returned to Step S24.

When it is determined that the big basis number of the big basis a is set by the primary search process (YES in Step S29), the secondary search process is performed based upon index information corresponding to the big basis a (Step S30). Namely, image data, the recorded time of which is closest to the designated time, is searched based upon the index information corresponding to the big basis a. More specifically, index information with respect to images within a group corresponding to the big basis a are specified based upon an index address, a start time and an end time, having been written into the big basis a, and image data having the recorded time closest to the designated time is searched based upon the specified index information. The image data searched by the secondary search is displayed on the monitor.

Thereafter, the designated time and the big basis number of the big basis b as a big basis number of a subject file for start of the primary search next time are stored (Step S31). The search process this time is then completed.

In Step S24 above, all of already created big basis files were searched when the search end condition is determined to be satisfied, and it is determined that no big basis file where the designated time is present between the start time and the end time was found. The process is then shifted to Step S31.

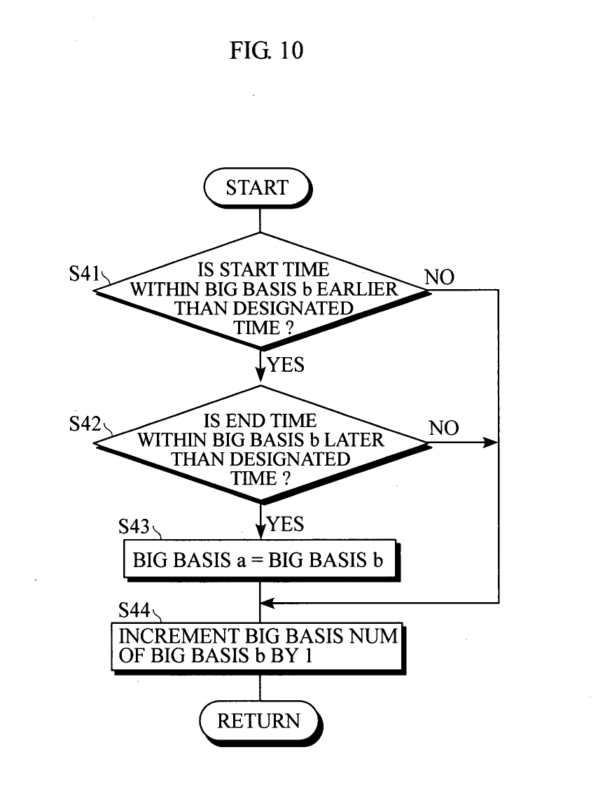

FIG. 10 is a procedure for the first search process based upon the big basis b which is performed in Step S28 of FIG. 9.

First, it is determined whether or not the start time having been written into the big basis b is earlier than the designated time (Step S41). When the start time having been written into the big basis b is earlier than the designated time, it is determined whether or not the end time having been written into the big basis b is later than the designated time (Step S42).

When the end time having been written into the big basis b is later than the designated time, the big basis number of the big basis b is set as the big basis number of the big basis a (Step S43). Further, the big basis number of the big basis b is incremented by one, to update the big basis number of the big basis b (Step S44). The process is then shifted to Step S29.

When it is determined in Step S41 above that the start time having been written into the big basis b is later than the designated time or it is determined in Step S42 above that the end time having been written into the big basis b is earlier than the designated time, the process is shifted to Step S44, and the big basis number of the big basis b is incremented by one, to update the big basis number of the big basis b. The process is then sifted to Step S29.

When a search command designating the same time is again inputted after completion of the search process in FIG. 9, search is started from the big basis file corresponding to the big basis number of the big basis b held in Step S31.

For example, in FIG. 4, when a group for search start of a first primary search process is the group 1 (G1) and a designated time (search time) is a designated time shown in FIG. 4, the group 2 (G2) is found as a group where the designated time is present between the start time and the end time. Therefore, a recorded image C, the recorded time of which is closest to the designated time, is searched from within the group 2 (G2). Further, a big basis file corresponding to the group 3 (G3) as a group subsequent to the group 2 (G2) found this time is stored as a subject big basis file for start of a next primary search.

In a case where the user looks at an image to find the image different from a desired one or some other cases, when the user restart search by the same designated time, the primary search is started from the group 3 (G3). As a group where the designated time is present between the start time and the end time, the group 3 (G3) is found. An image data D having the recorded time closest to the designated time is searched from within the group (G3).

Therefore, in a case where a plurality of recorded images are present whose recorded times are almost identical due to the time return, when a time in the vicinity of the recorded times of those plurality of recorded images is designated by search by time designation, all of the recorded images in the vicinity of the designated time are made easy to search.

It is to be noted that, when a big basis file where the designated time is present between the start time and the end time is not searched as a result of search by time designation, a width of a may be given to the start time and the end time of each big basis file (“start time”−α, “end time”+α). Then, a big basis file where the designated time is present between (“start time”−α) and (“end time”+α) may be searched, and a recorded image having the recorded time closest to the designated time may be searched based upon the searched big basis file.

What is claimed is:

1. A video recording and reproducing apparatus in which index information made up of a recorded time of an image and a storage address of the image is stored into a storage unit every time an image is recorded into the storage unit during recording,
the apparatus comprising:
a group management information file creating circuit which groups recorded images, during recording, such that
when a system time at the time of input of an image intended to be recorded this time is later than a recorded time of an image recorded last time, the image that is recorded this time is included in a current recorded image group, and
when the system time at the time of input of the image intended to be recorded this time is earlier than the recorded time of the image recorded last time, a new recorded image group is formed from the image that is recorded this time, and
the group management information file creating circuit which creates, for each group, a group management information file which stores group management information including a start time as a recorded time of an image recorded first within the group, an end time as a recorded time of an image recorded last within the group, and an address at which index information of the image recorded first within the group is stored in the storage unit;
a circuit which performs, during search by time designation, a primary search process to search one group management information file where a designated time is present between the start time and the end time; and
a circuit which, when one group management information file is found where the designated time is present between the start time and the end time during the primary search process, performs a secondary search process to search a recorded image having a recorded time closest to the designated time based upon index information of the recorded images in the group corresponding to the group management information file.

2. A video recording and reproducing apparatus in which index information made up of a recorded time of an image and a storage address of the image is stored into a storage unit every time an image is recorded into the storage unit during recording,
the apparatus comprising:
a group management information file creating circuit which groups recorded images, during recording, such that
when a system time at the time of input of an image intended to be recorded this time is later than a recorded time of an image recorded last time, the image that is recorded this time is included in a current recorded image group, and
when the system time at the time of input of the image intended to be recorded this time is earlier than the recorded time of the image recorded last time, a new recorded image group is formed from the image that is recorded this time, and
the group management information file creating circuit which creates, for each group, a group management information file which stores group management information including a start time as a recorded time of an image recorded first within the group, an end time as a recorded time of an image recorded last within the group, and an address at which index information of the image recorded first within the group is stored in the storage unit;
a circuit which performs, during search by time designation, a primary search process to search one group management information file where a designated time is present between the start time and the end time, sequentially from a group management information file stored during the last search as a subject file for start of next primary search; and
a circuit which, when one group management information file is found where the designated time is present between the start time and the end time during the primary search process, performs a secondary search process to search a recorded image having a recorded time closest to the designated time based upon index information of the recorded images in the group corresponding to the group management information file, and stores a group management information file that was intended to be subjected to the primary search process subsequent to the found group management information file, as a subject file for start of the next primary search.

3. The video recording and reproducing apparatus according to claim 1 or 2, wherein
the group management information file creating circuit comprises:
a circuit which determines whether or not a return time as a difference between the recorded time of the image recorded last time and the system time at the time of input of the image intended to be recorded this time is not larger than a prescribed value when the system time is earlier than the recorded time of the image recorded last time; and
a circuit which makes a new recorded image group formed from the image that is recorded this time when the return time is larger than the prescribe value, and makes the recorded time of the image that is intended to be recorded this time changed to a time later than the recorded time of the image recorded last time, while making the image that is recorded this time included in the current recorded image group, when the return time is not larger than the prescribed value.

4. A video recording and reproducing apparatus in which index information made up of a recorded time of an image and a storage address of the image is stored into a storage unit every time an image is recorded into the storage unit during recording,
the apparatus comprising:
a group management information file creating means which groups recorded images, during recording, such that
when a system time at the time of input of an image intended to be recorded this time is later than a recorded time of an image recorded last time, the image that is recorded this time is included in a current recorded image group, and
when the system time at the time of input of the image intended to be recorded this time is earlier than the recorded time of the image recorded last time, a new recorded image group is formed from the image that is recorded this time, and
the group management information file creating means which creates, for each group, a group management information file which stores group management information including a start time as a recorded time of an image recorded first within the group, an end time as a recorded time of an image recorded last within the group, and an address at which index information of the image recorded first within the group is stored in the storage unit;
a means which performs, during search by time designation, a primary search process to search one group management information file where a designated time is present between the start time and the end time; and
a means which, when one group management information file is found where the designated time is present between the start time and the end time during the primary search process, performs a secondary search process to search a recorded image having a recorded time closest to the designated time based upon index information of the recorded images in the group corresponding to the group management information file.

5. The video recording and reproducing apparatus according to claim 4, wherein
the group management information file creating means comprises:
a means which determines whether or not a return time as a difference between the recorded time of the image recorded last time and the system time at the time of input of the image intended to be recorded this time is not larger than a prescribed value when the system time is earlier than the recorded time of the image recorded last time; and
a means which makes a new recorded image group formed from the image that is recorded this time when the return time is larger than the prescribe value, and makes the recorded time of the image that is intended to be recorded this time changed to a time later than the recorded time of the image recorded last time, while making the image that is recorded this time included in the current recorded image group, when the return time is not larger than the prescribed value.
